(19) United States
(12) Patent Application Publication
(10) Pub. No.: US 2002/0079719 A1
(43) Pub. Date: Jun. 27, 2002

(54) Vehicle having a removable rigid roof

(76) Inventors: Steven Crijns, Norwich (GB); Nicholas Gwinnut, Bromsgrove (GB)

Correspondence Address: LUEDEKA, NEELY & GRAHAM, P.C., P O BOX 1871, KNOXVILLE, TN, 37901, US

(21) Appl. No.: 09/977,631

(22) Filed: Oct. 15, 2001

(30) Foreign Application Priority Data
Oct. 16, 2000 (GB) 0025344.3

(51) Int. Cl. B62D 25/06

(52) U.S. Cl. 296/102

(57) ABSTRACT

The present invention (with reference to FIG. 1) relates to a vehicle (10) having a removable rigid roof (20) which can be attached by releasable attachment means above and covering a cabin of the vehicle 10. The removable rigid roof (20) is provided with a pair of hinged sections (40) each hingedly connected to the remainder of the removable rigid roof (20). Each hinged section (40) can be pivoted between a first position in which the hinged section (40) lies in the plane of the rigid roof (20) and a second position in which the hinged section is pivoted upwardly out of the plane of the rigid roof (20). Each hinged section (40) has a transverse edge which lies above one of a pair of doors of the vehicle (10) when the hinged section is in the first position thereof. Pivoting of each hinged section (40) to the second position thereof creates an aperture lying adjacent one of the pair of doors, which aperture aids ingress to and egress from the vehicle (10).

### FIELD OF THE INVENTION

The present invention relates to a vehicle having a removable rigid roof.

### BACKGROUND OF THE INVENTION

It is known for vehicles such as sports cars to be provided with removable “soft top” or “hard top” roofs. It is also known for such vehicles to be provided with both versions of roof, the “soft top” and “hard top” roofs of the vehicle being interchangeable. Furthermore, it is also known for a vehicle to be provided with a so-called “targa top” roof which typically comprises a fixed roof having a panel or panels which can be lifted out of the roof and stored, for instance, in the boot.

### SUMMARY OF THE INVENTION

The present invention seeks to provide a removable hard top roof for a vehicle which incorporates the concept of targa top panels which are in themselves removable from the hard top roof.

In a first aspect, the present invention provides a vehicle having a removable rigid roof which can be attached by releasable attachment means above and covering a cabin of the vehicle, wherein the removable rigid roof is provided with a hinged section which is hingedly connected to the remainder of the removable rigid roof, which can be pivoted between a first position in which the hinged section lies in the plane of the rigid roof and a second position in which the hinged section is pivoted upwardly out of the plane of the roof and which has a transverse edge which lies above a door of the vehicle when the hinged section is in the first position thereof, whereby pivoting of the hinged section to the second position creates an aperture in the roof adjacent to the door, which aperture aids ingress to and egress from the vehicle through the door.

### BRIEF DESCRIPTION OF THE DRAWINGS

Preferred embodiments of the present invention will now be described by way of example only with reference to the accompanying drawings, in which:

FIG. 1 is a side elevation view of a vehicle fitted with a removable roof system according to the present invention;

FIG. 2 is a rear perspective view of the vehicle of FIG. 1;

FIG. 3 is a rear perspective view of the removable roof system according to the present invention showing a removable panel in the fully open position;

FIG. 4 is detail perspective view of a hinge of the removable panel illustrated in FIG. 3;

FIG. 5 is detail side elevation view of a leaf spring of the hinge of FIG. 4;

FIG. 6 is a detail view from inside and below of the removable panel in a closed position;

FIG. 7 is a perspective schematic illustration of one side of the closure mechanism of the removable panel shown in FIGS. 3 and 6;

FIG. 8 is a perspective schematic illustration of the other side of the closure mechanism of FIG. 7;

FIG. 9 is schematic illustration of the closure mechanism of FIGS. 7 and 8 shown in its position in the roof structure (certain parts removed for clarity);

FIG. 10 is a plan view from above of the lever handle and associated apparatus used to operate the closure mechanism of FIGS. 7 to 9;

FIG. 11 is a detail perspective view of a rotating block and associated apparatus according to the present invention; and

FIG. 12 is a schematic illustration of the function and operation of the rotating block of FIG. 11.

### DETAILED DESCRIPTION OF THE PREFERRED EMBODIMENTS

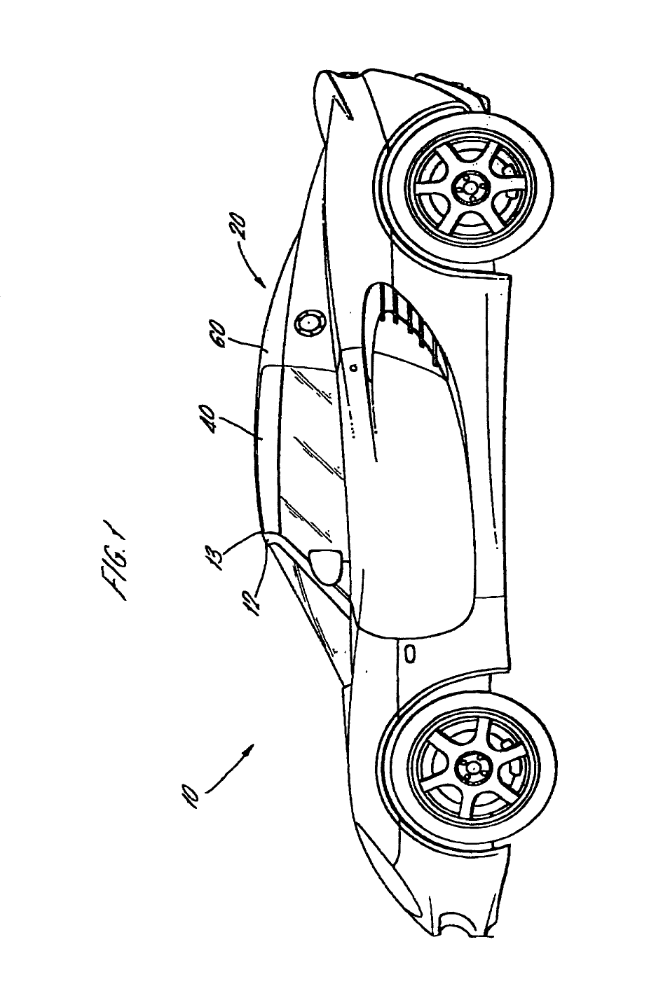

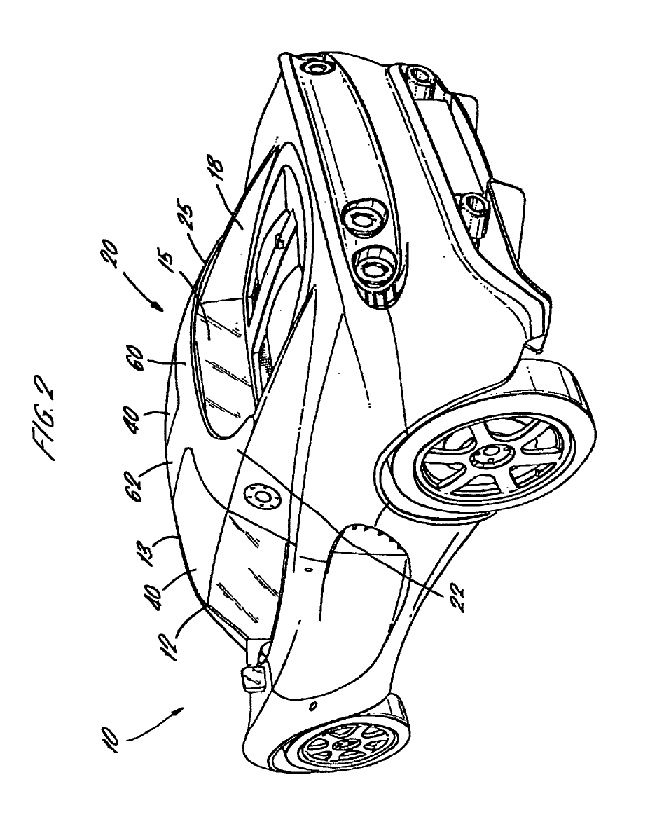

In FIGS. 1 and 2 there can be seen a vehicle 10 with a removable hard top 20. The hard top comprises a t-section 60 and removable targa panels 40.

The removable hard top 20 may be fitted to the vehicle 10 using any conventional fixing methods known in the art of removable hard top roofs. For instance, the top portion of the windscreen frame 12 may be provided with a recess 13 which runs transversely of the vehicle 10. A corresponding mating projection (not shown) may be provided along the front underside edge of the removable hard top 20 which sealingly engages in the recess 13. Resilient sealing members may be additionally provided to enhance the seal between the windscreen frame 12 and hard top 20 and to provide a resilient medium for damping vibration. A corresponding resilient sealing member (not shown) may also be provided on the top edge of rear windscreen 15 so as to interface with the underside of the hard top 20 and sealingly engage therewith.

At the rear of the hard top 20, mechanical fastening means may typically be employed to locate the rear lobes 22 of the hard top 20 to underlying body panels 18 of the vehicle 10. Such mechanical fastening means may include releasable snap fit locking pins or other mechanical interlocking devices known in the art.

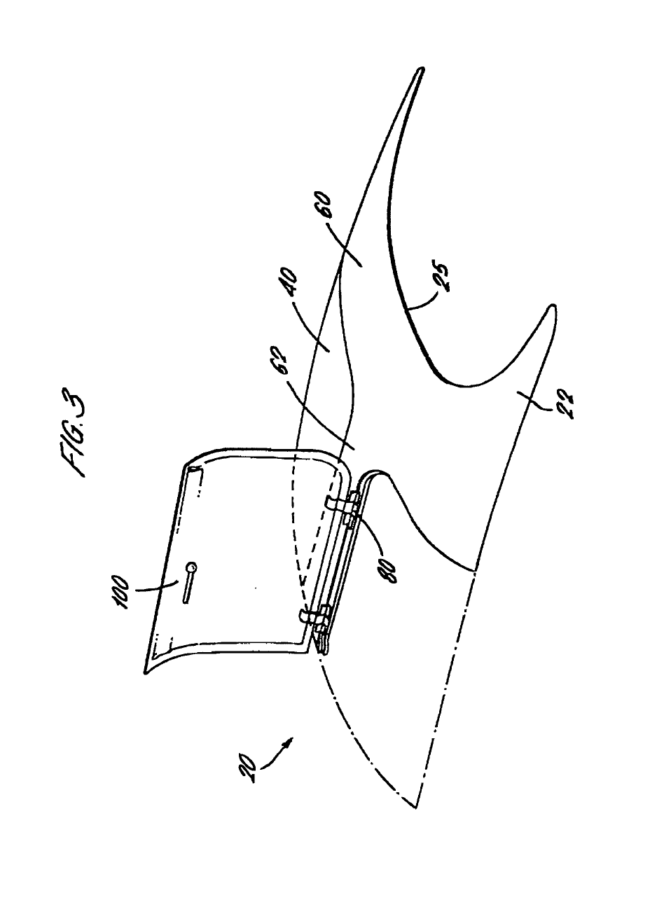

With reference now to FIG. 3, the removable hard top 20 can be seen removed from the vehicle with one of the removable targa panels 40 illustrated in a fully open position. In the preferred embodiment illustrated, the t-section 60 of the hard top 20 can be seen to comprise a central section 62 extending rearwardly from the front windscreen frame 12 of the vehicle 10 between the two removable targa panels 40, after which it extends to traverse the whole width of the hard top 20, culminating in a rearward most edge 25 having lobes 22.

Each of the removable targa panels 40 is removably attached to the central portion 62 of the t-section 60 via hinges 80 which are attachable to and detachable from recesses (not shown) provided in the central section 62. The respective targa panels 40 extend rearwardly from the windscreen frame 12 until they are just short of the rear windscreen frame 15, at which point the central section 62 resumes its full width 60. Each of the targa panels provides a cant rail against which a top of a window of a vehicle door can seal.

It will be appreciated, however, that the t-section 60 of the hard top 20 could be in the form of an i-section which additionally has a forward portion which traverses the width of the vehicle cabin and interfaces with the entire top edge 13 of the windscreen frame 12. In such a case, the removable targa panels 40 would be fully enveloped by the i-section of the hard top 20.

Apart from being of reverse hand, the two removable targa panels 40 are otherwise identical and will therefore be described in this specification with reference to the left hand targa panel 40 which is illustrated in the fully open position in FIG. 3.

Each targa panel 40 is provided with a locking mechanism 100 and is hingedly connected to the central section 62 of the hard top 20 via hinges 80. The hinges 80 are attached to the targa panel 40 and provide the mechanism by which the targa panel 40 is attachable to and detachable from the central section 62 of the hard top 20.

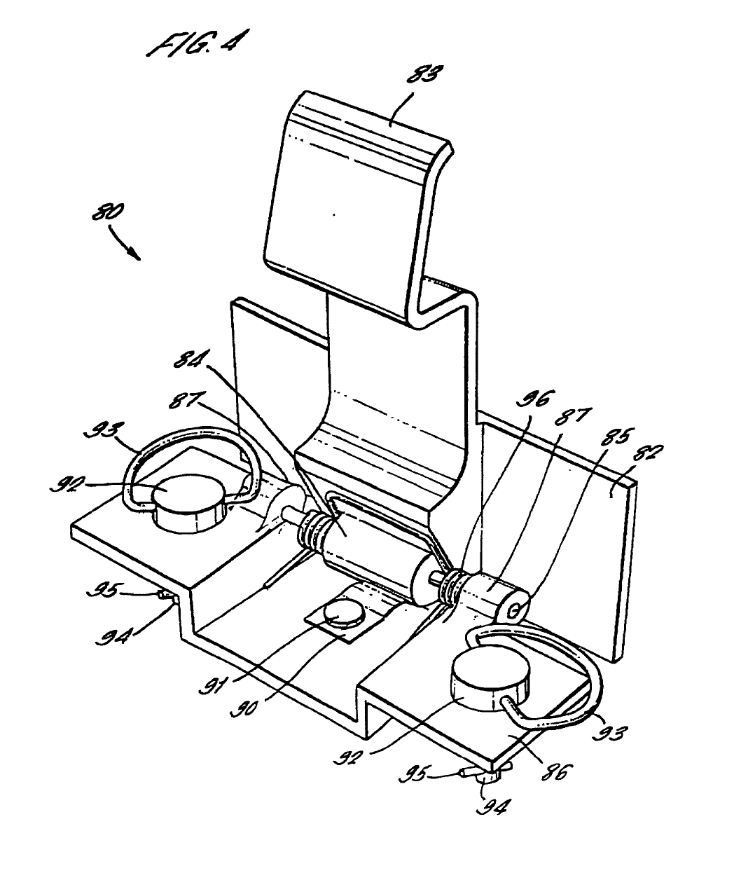

A detailed view of the hinge mechanism 80 is illustrated in FIG. 4. Each hinge 80 can be seen to comprise an upper plate 82, which is connectable to the targa panel 40, and a lower plate 86 connectable to the central section 62 of the hard top 20. Upper plate 82 can be seen to comprise a protrusion 83 formed with features which co-operate with mating features provided on the targa panel 40. In the particular embodiment illustrated, the targa panel 40 interfaces with protrusion 83 but does not extend over or cover the upper plate 82. The targa panel 40 may be affixed to protrusion 83 by any known mechanical fixing means and/or adhesive. As such, the connection of the targa panel 40 to the upper portion 82 may be made permanent or temporary. It will also be appreciated that in an alternative embodiment, the targa panel 40 could fully enclose the entire upper plate 82 and protrusion 83. This is essentially an aesthetic consideration for the designer of the vehicle 10.

At the lower end of upper portion 82 there is provided a hinge portion 84 which carries a shaft 85 through its bore, about which the upper portion 82 is rotatable. Additionally, there is provided a detent means 88 at a lower central section of upper plate 82 whose function will be described further below. The shaft 85 extends from hinge portion 84 into hinge portions 87 provided either side on a lower plate 86 of the hinge mechanism 80.

Lower plate 86 is attachable to and removable from a co-operating recess provided in the central portion 62 of the hard top 20. Attachment to and detachment from the central portion 62 is effected by locking pins 92. Each locking pin 92 has a shank portion 94 passing through an aperture provided in the lower plate 86 and extending down into the mating structure in the central portion 62 of the hard top 20. Rotation of the locking pin 92, which may be effected via hoop 93 provided in the head of the locking pin 92, causes a locking spindle 95 provided at a lower end of the shank 94 to interact with a mating structure provided (not shown) in central portion 62, causing the lower plate 86, upper plate 82 and targa top 40 to be pulled down and securely anchored to the central portion 62 of the hard top 20. Typically, the locking pin is designed such that a 45 degree rotation of the pin 92 is sufficient to move the pin 92 between a secured locking position and a free unlocked position in which the entire hinge mechanism 80 (and targa panel 40) may be lifted from its anchor point in the central portion 62.

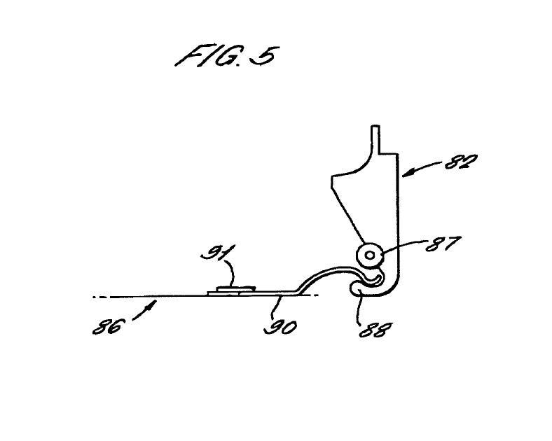

Additionally provided on the lower plate 86 is a leaf spring 90 secured in position by rivet 91. As can best be seen in FIG. 5, the leaf spring 90 is of arcuate form at its end nearest to the hinge portion 84 of upper plate 82 so that when the targa panel 40 is raised into a substantially vertical position, the suitably shaped detent 88 provided on the lower portion of upper plate 82 passes under the arcuate portion of leaf spring 90 and securely holds the targa panel 40 in the fully open (i.e. substantially vertical) position. The spring force of the leaf spring 90 and/or shape of the detent 88 may be adjusted to give sufficient force to withstand undesirable forces (e.g. wind) acting to urge the targa panel 40 closed.

There is additionally provided a coil spring 96 located on the shaft 85 between the hinge portions 87 on lower plate 86 and the hinge portion 84 provided on upper plate 82. The coil spring 96 has end portions resting on and acting against the lower plate 86 and a central portion 104 provided between its two coils which acts upon upper plate 82. The coil spring 96 acts to urge apart the upper plate 82 and lower plate 86 respectively, and this serves to reduce the apparent weight experienced by an operator when lifting the targa panel 40 by rotation about shaft axis 85.

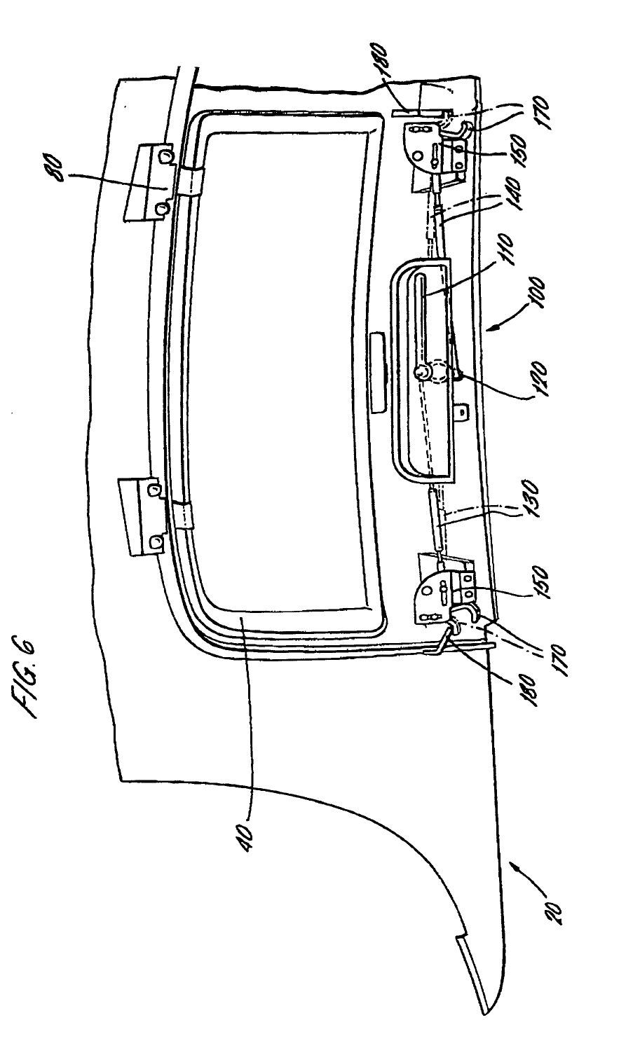

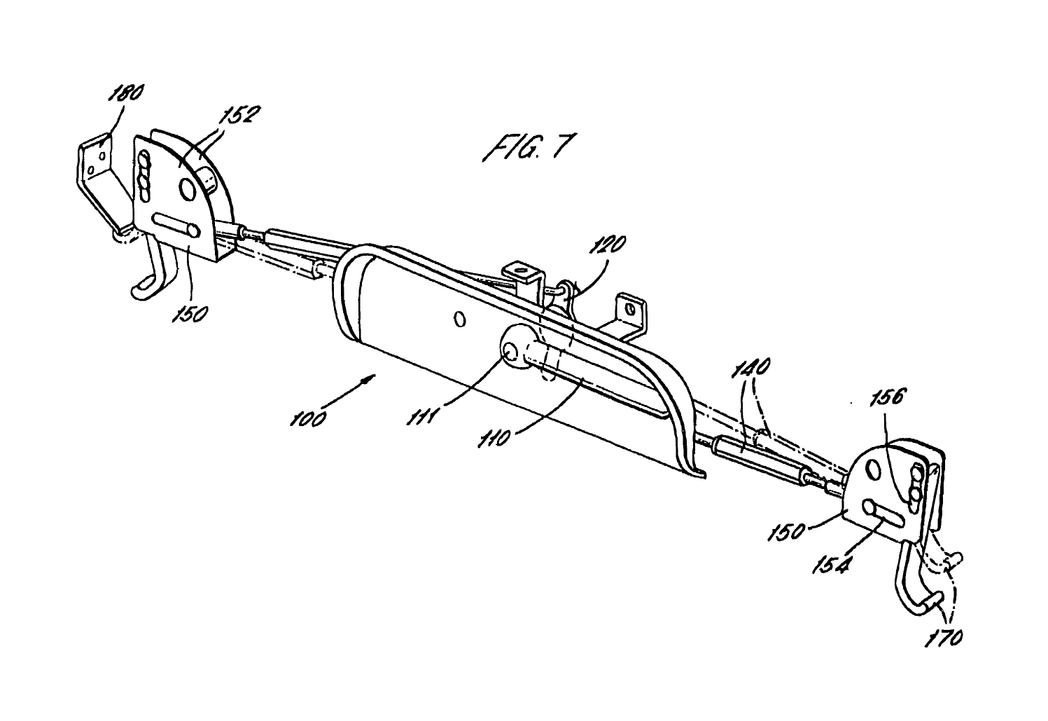

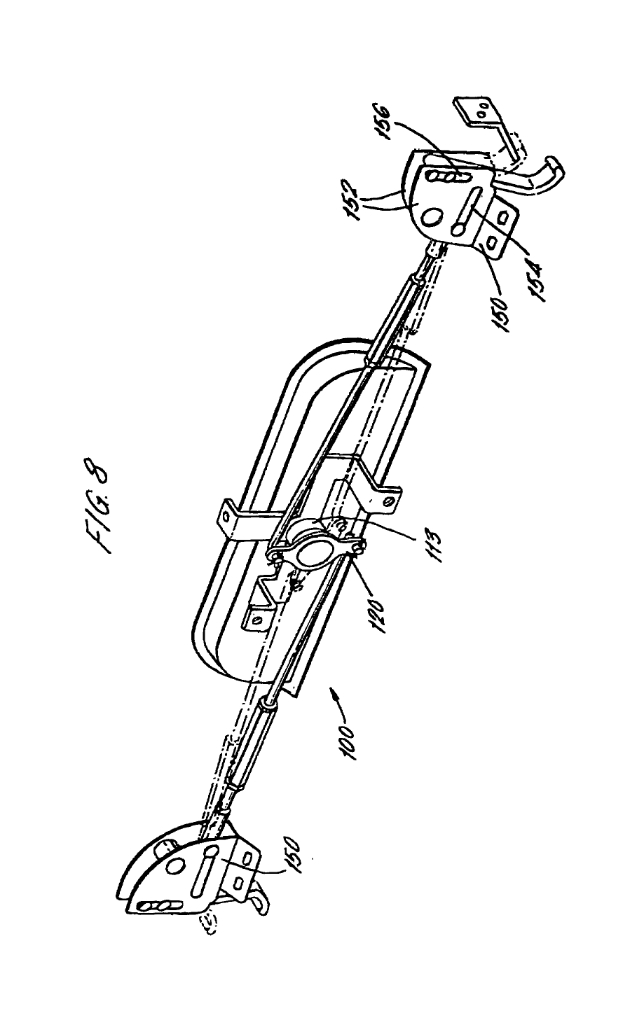

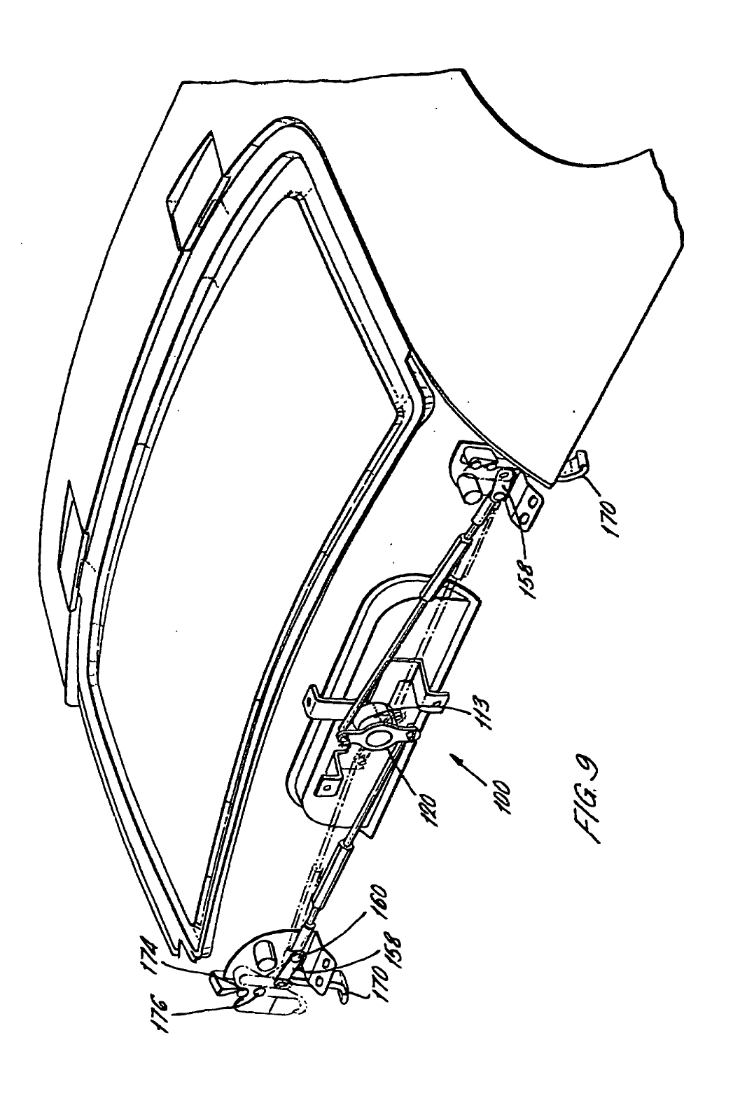

For securing the targa panel 40 in a closed position integral with the hard top 20, there is provided a locking assembly 100 on the underside of the outermost edge of each targa panel 40. This arrangement is illustrated in FIGS. 6 through to 12. The locking assembly 100 is shown separate from the targa panel 40 in FIGS. 7 to 9 for greater clarity.

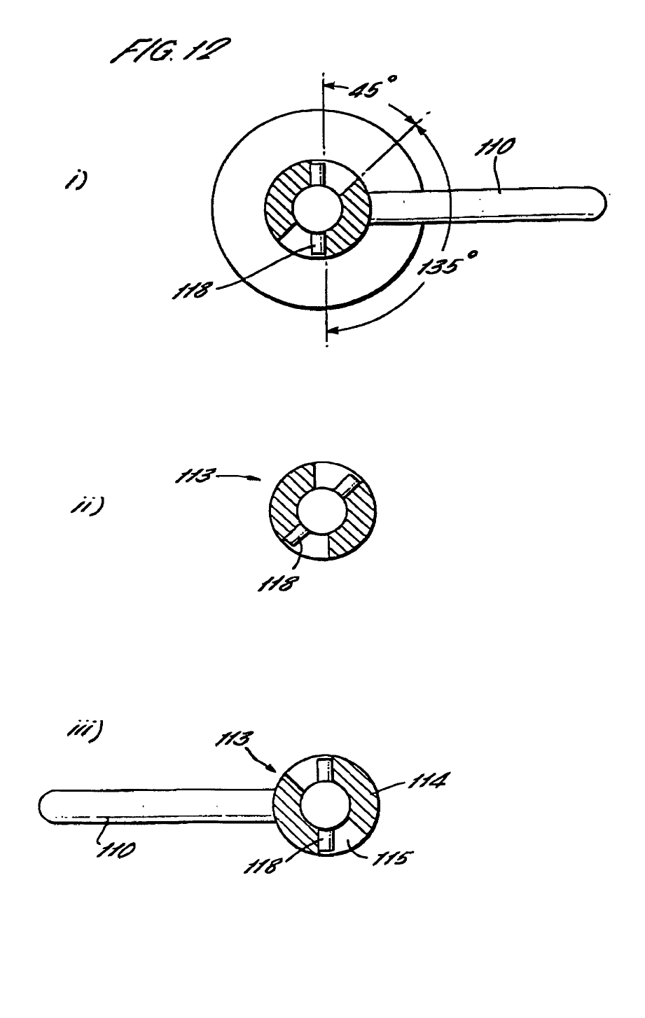

With reference to FIGS. 6 to 12, the locking assembly 100 comprises lever handle 110 which is movable through 180 degrees from a first locked position to a second open position. The lever handle 110 effects locking and opening of the targa panel 40 via a lobed plate 120 which effects movement of locking mechanisms 150 via control rods 130, 140. Whilst the lever handle 110 rotates through 180 degrees so as to prevent the lever handle protruding below the roof line of the targa panel 40 in either of its locked or unlocked positions, the lobed plate 120 which actuates the control rods 130, 140 only operates through a rotation much less than 180 degrees, typically between 90 and 135 degrees. This is achieved using a cylindrical rotating block 113 which is freely mounted on a shaft 111. Shaft 111 is fixedly attached to lever handle 110 and is provided with a spindle 118 (see FIG. 12) which can act the on rotating block 113. In turn, the rotating block 113 is linked to lobed plate 120 which in itself is connected to and actuates the control rods 130, 140.

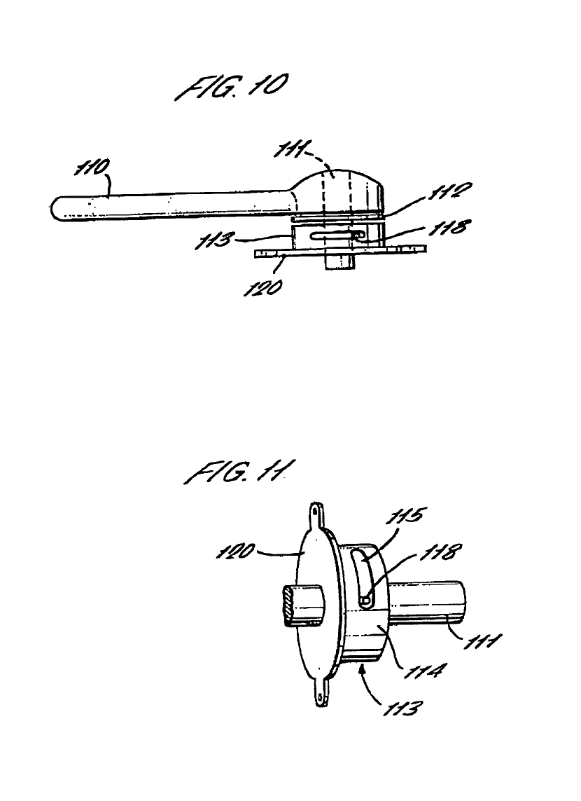

The rotating block 113 is provided with solid sections 114 and cut away sections 115 as illustrated schematically in FIG. 12. Thus, rotation of the lever handle 110 through, say, the first 45 degrees of travel causes the spindle 118 to move freely in the cut away sections 115 without acting on the rotating block 113. Following rotation of the lever handle 110 by 45 degrees, the spindle 118 is brought into contact with the two solid sections 114 of the rotating block 113 causing rotation of the rotating block 113 and consequent rotation of the lobed plate 120. This, in turn, results in corresponding actuation of the control rods 130, 140 which are respectively connected to the lobes of lobed plate 120. This continues for a further 135 degrees of rotation until the lever handle 110 has travelled through 180 degrees to its other extreme position. This actuation process is simply repeated on the return stroke, but the action is reversed. In order that the lever handle 110 is maintained in its two extreme positions and is not free to fall (until contact of spindle 118 is established with a solid portion 114 of rotating block 113) when not in use, a friction disc 112 is provided in contact alongside lever handle 110, as illustrated in FIG. 10

Each of the control rods 130, 140 is linked to and actuates one of the two lock mechanisms 150 provided Each lock mechanism 150 is identical, save for being of reverse hand, as illustrated in FIGS. 6 to 9. Each lock mechanism 150 comprises a body having spaced apart side plates 152 provided with cut outs 154 and 156 which define guide tracks for pivoting or locating pins extending between the two side plates 152.

The ends of the control rods 130, 140 distal from the lever handle 110 are each pivotally connected to a link 158 via pin 160. Pin 160 passes through cut-outs 154 provided in each side plate 152 and is further provided with a flange on each end thereof to permit travel of the pin 160 along the guide track 154 whilst being prevented from being dislodged from either side plate 152. The opposite end of link 158 is pivotally connected to a detent hook 170 slidably mounted between the side plates 152 via pins 174, 176 which are spacedly positioned on the shank of the detent hook 170 to permit travel along the guide track 156 provided in each of the two side plates 152.

In a first open position of the lock assembly 100, each control rod 130, 140 is fully retracted such that pin 160 and link 158 cause detent hook 170 to be clear of the catch 180. This permits opening of the targa panel 40 about its hinge mechanism 80. To achieve a second closed position, the targa panel 40 is rotated about its hinge mechanism 80 to a closed position where it is flush with the t-section 60 of the hard top 20. Lever handle 110 is then rotated about its axis and following approximately 45 degrees of rotation, the lever handle 110 actuates the lobed disk 120 via spindle 118 and rotating block 113 causing actuation of the control rods 130, 140. In turn, the control rods 130, 140 actuate the link 158 via the pivot pin 160 which in itself causes the detent hook 170 to travel along the guide track 156, the motion of which is defined by the pins 174 and 176 constrained in the guide track 156. The consequent movement of the detent hook 170 is such that it moves outboard of the lock mechanism 150 and towards the catch 180 until it is brought into contact with the catch 180. Locking engagement of the detent hook 170 with catch 180 is achieved when the lobed disk 120 is rotated past an over centre position, the maximum compression force in the control rod 130, 140 being achieved at dead centre. This maximum compression force at dead centre resists movement back towards the over centre position and instead urges the detent hook 170 into locking contact with the catch 180.

In the preferred embodiment illustrated, the catch 180 for the lock mechanism 150 of the forward end of the targa panel 40 is fixedly attached to the windscreen pillar (not shown). Meanwhile, the catch 180 provided for the lock mechanism 150 at the rearward most end of the targa panel 40 is provided on the underside of the t-section 60 of the hard top 20 at a position adjacent to the lock mechanism 150.

The provision of the pins 92 allows the panels 40 to be detached from the remainder of the hard top 20 to be stored, for instance, in the boot of the vehicle. Thus, not only is the whole hard top 20 removable, but the panels 40 are also independently removable. Whilst it may not be possible to store the whole top 40 in e.g. the boot of a sports car, it will be possible to store the panels 40. The hinged attachment of the panels 40 to the remainder of the hard top 20 allows the panels 40 to be hinged upwardly to allow ingress to and egress from the vehicle. In this regard since the cant rails of the vehicle are provided by the edges of the panels 40, when the panels 40 are hinged upwardly and the doors opened, each of the driver and passenger are provided with an uninterrupted aperture defined by the construction of the aperture left by an open door and an aperture left by a removed panel 40.

What is claimed is:

1. A vehicle having a removable rigid roof which can be attached by releasable attachment means above and covering a cabin of the vehicle, wherein the removable rigid roof is provided with a hinged section which is hingedly connected to the remainder of the removable rigid roof, which can be pivoted between a first position in which the hinged section lies in the plane of the rigid roof and a second position in which the hinged section is pivoted upwardly out of the plane of the roof and which has a transverse edge which lies above a door of the vehicle when the hinged section is in the first position thereof, whereby pivoting of the hinged section to the second position creates an aperture in the roof adjacent to the door, which aperture aids ingress to and egress from the vehicle through the door.

2. A vehicle as claimed in claim 1 wherein the hinged section is connected to the remainder of the rigid roof by hinge means which has releasable connection means, the releasable connection means connecting the hinged section with the remainder of the rigid roof and being manually operable whereby a user can manually detach the hinged section from the remainder of the rigid roof.

3. A vehicle as claimed in claim 1 wherein the hinged section is provided with manually operable locking means whereby the hinged section can be secured in the first position thereof and subsequently released for pivoting to the second position thereof.

4. A vehicle as claimed in claim 2 wherein the hinged section is provided with manually operable locking means whereby the hinged section can be secured in the first position thereof and subsequently released for pivoting to the second position thereof.

5. A vehicle having a removable rigid roof which can be attached by releasable attachment means above and covering a cabin of the vehicle, wherein the removable rigid roof is provided with a pair of hinged sections each hingedly connected to the remainder of the removable rigid roof, each of which can be pivoted between a first position in which the hinged section lies in the plane of the rigid roof and a second position in which the hinged section is pivoted upwardly out of the plane of the roof, each hinged section having a transverse edge which lies above one of a pair of doors of the vehicle when the hinged section is in the first position thereof, the pair of doors lying on transversely opposite sides of the vehicle, whereby pivoting of the hinged sections to the second positions thereof creates a pair of transversely spaced apart apertures lying one each adjacent one of the pair of doors, which apertures aid ingress to and egress from the vehicle through the doors.

6. A vehicle as claimed in claim 5 wherein each hinged section is connected to the remainder of the rigid roof by hinged means which has releasable connection means, the releasable connection means connecting each hinged section with the remainder of the rigid roof and being manually operable whereby a user can manually detach each hinged section from the remainder of the rigid roof.

7. A vehicle as claimed in claim 5 wherein each hinged section is provided with manually operable locking means whereby the hinged section can be secured in the first position thereof and subsequently released for pivoting to the second position thereof.

8. A vehicle as claimed in claim 6 wherein each hinged section is provided with manually operable locking means whereby the hinged section can be secured in the first position thereof and subsequently released for pivoting to the second position thereof.

9. A vehicle having a removable rigid roof which can be attached by releasable attachment means above and covering a cabin of the vehicle, wherein the removable rigid roof is provided with a hinged section which is hingedly connected to the remainder of the removable rigid roof, which can be pivoted between a first position in which the hinged section lies in the plane of the rigid roof and a second position in which the hinged section is pivoted upwardly out of the plan of the roof and which has a transverse edge which lies above a door of the vehicle when the hinged section is in the first position thereof, whereby pivoting of the hinged section to the second position creates an aperture in the roof adjacent to the door, which aperture aids ingress to and egress from the vehicle through the door, and wherein the hinged section is connected to the remainder of the rigid roof by hinge means which has releasable connection means, the releasable connection means connecting the hinged section with the remainder of the rigid roof and being manually operable whereby a user can manually detach the hinged section from the remainder of the rigid roof.

10. A vehicle as claimed in claim 9 wherein the hinged section is provided with manually operable locking means whereby the hinged section can be secured in the first position thereof and subsequently released for pivoting to the second position thereof.

11. A vehicle wherein the removable rigid roof is provided with a pair of hinged sections each hingedly connected to the remainder of the removable rigid roof, each of which can be pivoted between a first position in which the hinged section lies in the plane of the rigid roof and a second position in which the hinged section is pivoted upwardly out of the plane of the roof, each hinged section having a transverse edge which lies above one of a pair of doors of the vehicle when the hinged section is in the first position thereof, the pair of doors lying on transversely opposite sides of the vehicle, whereby pivoting of the hinged sections to the second positions thereof creates a pair of transversely spaced apart apertures lying one each adjacent one of the pair of doors, which apertures aid ingress to and egress from the vehicle through the doors and wherein each hinged section is connected to the remainder of the rigid roof by hinge means which has releasable connection means, the releasable connection means connecting each hinged section with the remainder of the rigid roof and being manually operable whereby a user can manually detach each hinged section from the remainder of the rigid roof.

12. A vehicle as claimed in claim 11 wherein each hinged section is provided with manually operable locking means whereby each hinged section can be secured in the first position thereof and subsequently released for pivoting to the second position thereof.
